(19) United States
(12) Patent Application Publication
(10) Pub. No.: US 2013/0066947 A1
(43) Pub. Date: Mar. 14, 2013

(54) System and Method for Managing Applications for Multiple Computing Endpoints and Multiple Endpoint Types

(71) Applicants: Rashed Ahmad, Mississauga (CA); Kaleem Ahmad, Toronto (CA); Dmytro Svrid, Mississauga (CA); Ky David Michael Patterson, Toronto (CA)

(72) Inventors: Rashed Ahmad, Mississauga (CA); Kaleem Ahmad, Toronto (CA); Dmytro Svrid, Mississauga (CA); Ky David Michael Patterson, Toronto (CA)

(73) Assignee: Web Impact Inc., Toronto (CA)

(21) Appl. No.: 13/447,043

(22) Filed: Apr. 13, 2012

Related U.S. Application Data
(63) Continuation of application No. PCT/CA2010/001633, filed on Oct. 15, 2010.
(60) Provisional application No. 61/251,883, filed on Oct. 15, 2009.

(51) Int. Cl. G06F 15/16

(52) U.S. Cl. 709/203

(57) ABSTRACT

A multi-endpoint application server is provided that allows administrators to create and update content and data for endpoint applications using content management capabilities that allows the administrators to control how the endpoint application should be presented and how it should behave for various end-point types. A runtime application can be provided to each endpoint, which is configured to obtain content that is managed and maintained from the server in the same way as a normal web browser-based application would. To enable such multiple endpoint types to experience the same or similar endpoint application experience, the multi-endpoint application server accepts requests from the runtime application and determines what kind of endpoint is making the request such that it can present the content to the runtime application in a manner that is deemed appropriate for the endpoint type.

This application is a continuation of PCT Patent Application No. PCT/CA2010/001633 filed on Oct. 15, 2010, which claims priority to U.S. Provisional Application No. 61/251,883 filed on Oct. 15, 2009, the contents of both applications being incorporated herein by reference.

### TECHNICAL FIELD

The following relates to systems and methods for managing applications for multiple computing endpoints and multiple endpoint types.

### BACKGROUND

The proliferation of mobile computing, for example using smart phones, laptop computers, and even in-vehicle systems, has increased the demand for mobile applications. Mobile applications tend to provide users with an experience that can appear seamless and visually appealing by taking advantage of the local computing hardware such as GPS, camera, video, etc. The downside of mobile applications from the administrative standpoint is that they can be expensive to develop and maintain and may need to be developed separately for different platforms. From the user's perspective, maintaining mobile applications can also be burdensome by requiring user intervention in order to update the local software, install patches, etc.

In contrast to the development of platform-specific mobile applications, mobile web or WAP based counterparts can be deployed. Mobile web pages utilize mobile browsing capabilities to display content in a browser according to the way it is rendered by the web-based application. Mobile web pages typically provide the same content regardless of which type of platform you are viewing it on and, as such, the smart phone user may have a degraded experience when compared to a desktop or laptop with a larger screen. Despite having a user experience that may be less preferred than a platform-specific mobile application, mobile web pages are typically significantly less inexpensive to develop, maintain, and deploy. The mobile web environment allows administrators to update content and user interfaces (UI) without the need for user intervention since the user is accessing the content directly through their browser.

It is therefore an object of the following to address the above-noted disadvantages.

### SUMMARY

In one aspect, there is provided a method for providing applications on multiple endpoint types, the method comprising: providing a runtime module capable of creating a user interface for an endpoint application from instructions provided in a communications protocol; and using the communications protocol to receive requests for content, logic, and user interface data, and to provide replies to the runtime module.

In another aspect, there is provided a method for providing applications on multiple endpoint types, the method comprising: obtaining a runtime module capable of creating a user interface for an endpoint application using instructions provided in a communications protocol; sending a request to an application server pertaining to use of the endpoint application; receiving a reply in accordance with the communications protocol with the instructions; and parsing the instructions to generate the user interface.

In yet another aspect, there is provided a method for enabling interactivity with an endpoint application, the method comprising: obtaining a message sent in response to a detected event; interpreting the message to determine one or more instructions for responding to the detected event; and providing the instructions to native or custom application programming interfaces (APIs) to perform a response to the event.

Computing devices, systems, and computer readable media configured to perform such methods are also provided.

### BRIEF DESCRIPTION OF THE DRAWINGS

Embodiments will now be described by way of example only with reference to the appended drawings wherein:

FIG. 1 is a block diagram of an exemplary system for managing applications for a plurality of endpoints and endpoint types.

FIG. 2 is a block diagram illustrating further detail of the application server shown in FIG. 1.

FIG. 3 is a block diagram illustrating further detail of the application server core shown in FIG. 2.

FIG. 4A is a block diagram illustrating further detail of a content management system (CMS) shown in FIG. 1.

FIG. 4B is a block diagram illustrating further detail of a content/data repository, source or feed shown in FIG. 1.

FIG. 5 is a block diagram illustrating further detail of an endpoint shown in FIG. 1.

FIG. 6 is a block diagram illustrating further detail of a portion of the endpoint shown in FIG. 5.

FIG. 7 is a block diagram illustrating further detail of another portion of the endpoint shown in FIG. 5.

FIG. 8 is a schematic diagram illustrating a distribution of kernel logic for each application within an endpoint.

FIG. 9 is flow diagram illustrating a runtime translation of an endpoint mark-up language (EML) document into instructions utilizing features on an endpoint.

FIG. 10A is a schematic diagram illustrating a hierarchy for a collection used in the EML format.

FIG. 10B is a schematic diagram illustrating a hierarchy for data encoding using the EML format.

FIG. 11 is a schematic diagram illustrating a hierarchy for a themes collection definition.

FIG. 12 is a schematic diagram illustrating a hierarchy for a views collection definition.

FIG. 13 is a schematic diagram for a socket instance definition.

FIG. 14 is a schematic diagram for a field instance definition.

FIG. 15 is a schematic diagram for a button field instance definition.

FIG. 16 is a schematic diagram for a label field instance definition.

FIG. 17 is a schematic diagram for a list box instance definition.

FIG. 18 is a block diagram illustrating an exemplary layout for a smart phone comprising a label field, socket, and button.

FIG. 19 is a flow diagram illustrating exemplary computer executable instructions for managing applications on multiple endpoints and endpoint types.

FIG. 20 is a flow diagram illustrating exemplary computer executable instructions for creating a new endpoint type.

FIG. 21 is a flow diagram illustrating exemplary computer executable instructions for the application server in FIG. 1 processing a request for content at runtime and returning a EML document.

FIG. 22 is a flow diagram illustrating exemplary computer executable instructions for launching a mobile application at an endpoint utilizing the runtime module shown in FIG. 1.

FIG. 23 is a schematic diagram illustrating handling of AWOM messages using the AWOM interpreter shown in FIG. 7.

FIG. 24 is a schematic diagram showing an example use case for the system shown in FIG. 1.

FIG. 25 is a schematic diagram showing another example use case for the system shown in FIG. 1.

FIG. 26 is a flow diagram illustrating example computer executable instructions for converting media files to requested formats on the fly.

### DETAILED DESCRIPTION OF THE DRAWINGS

It has been recognized that the advantages of platform-specific mobile applications can be combined with advantages of mobile web-based solutions to facilitate the development, deployment, and maintenance of mobile applications. As will be described further below, by combining these advantages, a single endpoint application can be centrally maintained and its content made available to multiple endpoints and multiple endpoint types. In this way, each endpoint application only needs to be developed once and can be managed from a single location without duplicating content or resources. An endpoint or medium may refer to any form of technology, both software and hardware and combinations thereof, that has the ability to utilize a endpoint application. The endpoint may be, for example, a smart phone, web browser, laptop/tablet PC, desktop PC, set-top box, in-vehicle computing system, RSS feed, social network, etc.

A multi-endpoint application server is provided that allows administrators to create and update content such as data, UI, styling, flow, etc., for endpoint applications using content management capabilities (e.g. via a content management system (CMS)) that allows the administrators to control how the endpoint application should be presented and how it should behave for various end-point types. This allows administrators to create a fully branded experience that exists on the user's endpoint device as a endpoint application as if it were programmed specifically for the platform which the endpoint device utilizes. The application server can be implemented with its own CMS or an existing CMS used by that administrator to allow the administrator to manage content in a way that is familiar to them. A global application server can be deployed to service multiple clients or an enterprise server can be deployed to manage content and applications for an enterprise which interacts with multiple endpoint types.

The application server described below provides a mechanism by which a endpoint application can be updated with new content, and have its entire user experience from UI to functionality modified from a single “portal” on the server side. Therefore, the cost of developing new branded endpoint applications can be reduced and the cost of maintaining and updating the endpoint application can also be significantly reduced, in particular as more and more endpoint types are added. For the administrator, a runtime application can be provided to each endpoint, which is configured to obtain content that is managed and maintained from the server in the same way as a normal web browser-based application would. To enable such multiple endpoint types to experience the same or similar endpoint application experience, the multi-endpoint application server accepts requests from the runtime application and determines what kind of endpoint is making the request such that it can present the content to the runtime application in a manner that is deemed appropriate for the endpoint type. In this way, the process can be made transparent to the user and thus seamless from the user's perspective. The administrator can easily configure the process and simplify the day-to-day management of content for multiple endpoint types and should be able to configure pre-existing endpoint types and be able to add new endpoint types to the system as they are needed.

As will be described below, in order to facilitate multiple endpoint types, the system that will be herein described utilizes a content communication protocol for handling communications between the multi-endpoint application server and the various endpoint types, and a runtime application on the endpoint that will interact with the application server to obtain new content and UI definitions. For ease of reference, the computer language utilized by the content communication protocol may be referred to as Endpoint Mark-Up Language (EML).

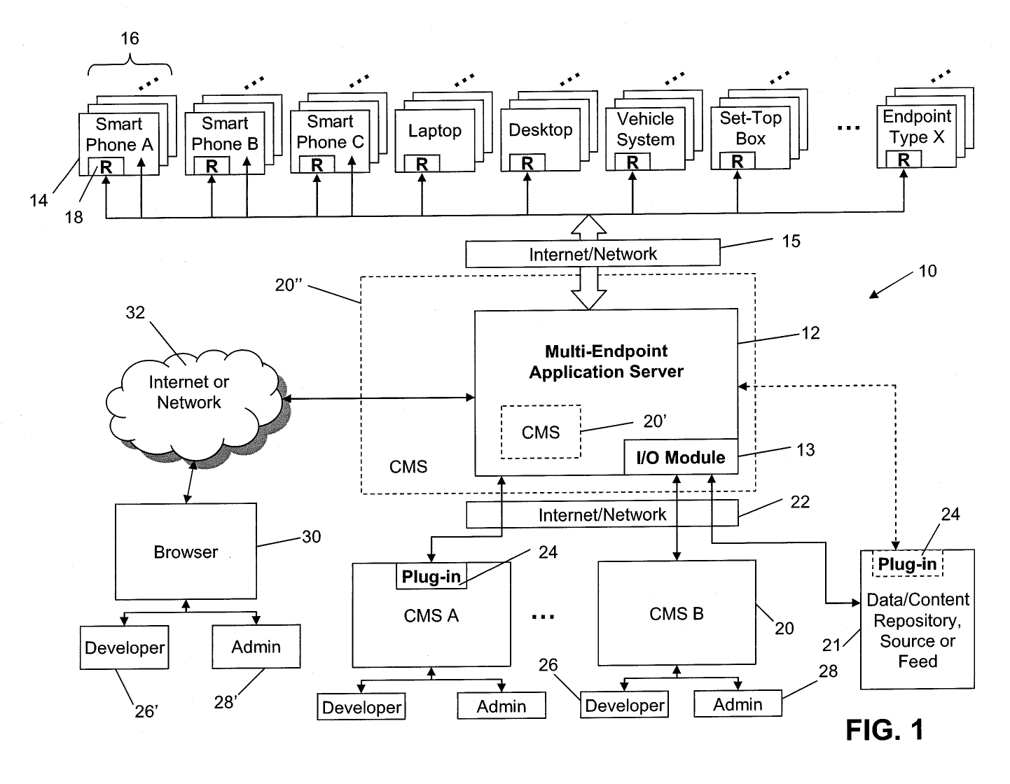

Referring now to FIG. 1, an endpoint application management system is denoted generally by numeral 10, and may hereinafter be referred to as the “system 10”. The system 10 comprises a multi-endpoint application server 12, which may hereinafter be referred to as the “application server 12” for brevity. The application server 12 is interposed between one or more but typically a plurality of endpoints 14 which are also typically of multiple endpoint types 16 and a CMS 20 (which may or may not reside on or near the application server 12) and/or a data/content repository, source or feed 21. In the example shown in FIG. 1, several endpoint types 16 are illustrated, including three different types of smart phones (A, B, C), laptops, desktops, vehicle systems, set-top boxes (e.g. for cable television), along with a generic endpoint type X. It can be appreciated that as noted above, an endpoint 14 can represent any software, hardware, or combination thereof that utilizes some form of application, for example a “mobile application” that is also available to various other endpoint types 16 with a similar user experience.

FIG. 1 illustrates several different configurations of the application server 12 and CMS 20. In one configuration of the CMS 20′, it may reside on the application server 12, and in another configuration, the application server 12 may be part of or otherwise programmed into the CMS 20″. In yet another, more typical configuration, the application server 12 is separate from one or more CMSs 20. It will be appreciated that the application server 12 can be a dedicated server per CMS 20 or can service multiple CMSs 20 as illustrated in FIG. 1. As such, a global or “common” application server 12 can be deployed to provide a central service, or an enterprise or “custom” application server 12 can be deployed to provide specific services to a single entity. Similar configurations are also applicable to the data/content repository, source or feed 21 (which for ease of reference will hereinafter be referred to as a “source” 21).

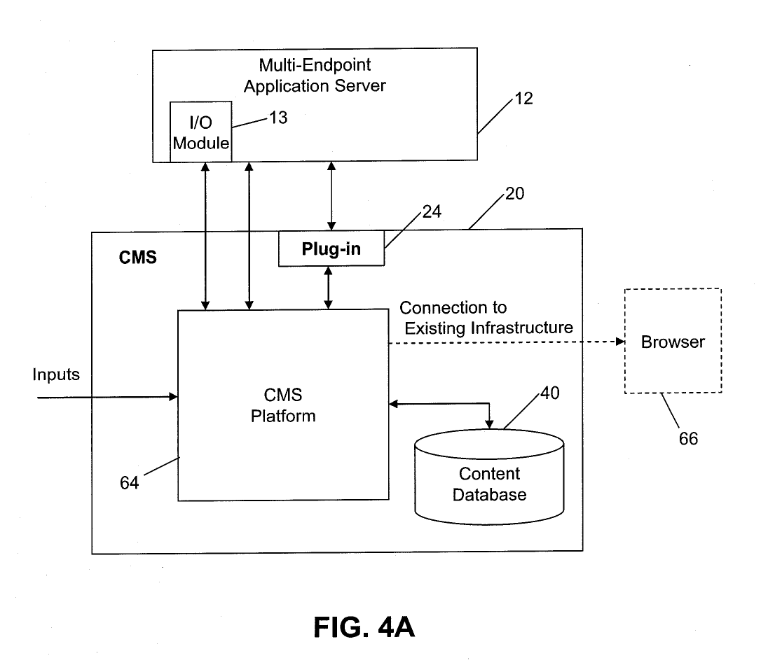

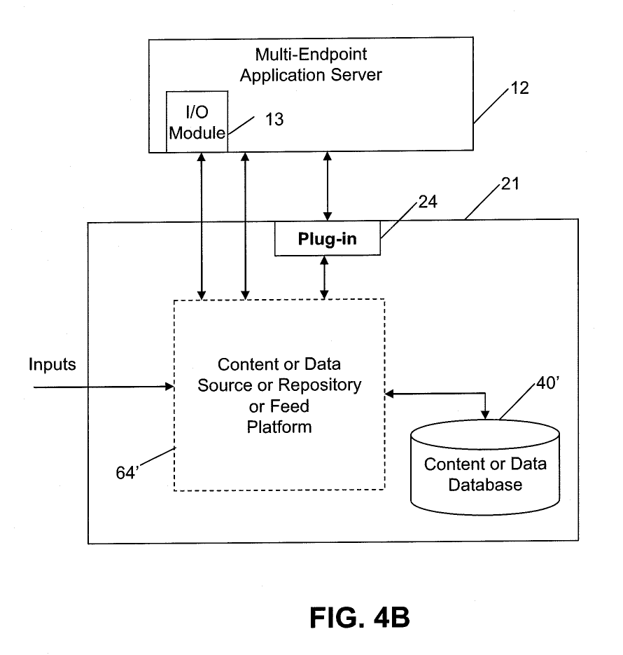

In this example, the CMS 20 and source 21 may comprise a plug-in 24, which provides a suitable interface for communicating with the existing features and infrastructure provided by an existing CMS type. In other embodiments, an I/O module 13 may be used at the application server 12 to translate or convert native data or content in whatever format to one that is familiar to the application server 12. In further embodiments, the CMS 20 or source 21 may already be in the proper format and thus no plug-in 24 or I/O module 13 may be needed (see also FIGS. 4A and 4B).

The CMS 20 typically provides access to developers 26 and administrators (Admin) 28 for developing, deploying, and maintaining content for the endpoint applications. A runtime module 18 is provided on each endpoint 14, which provides the runtime logic necessary to request content and data from the application server 12 and provide the endpoint application features to the user of the endpoint 14. In this way, the endpoint 14 does not have to maintain current views, styling and logic for each application it uses but instead can rely on the maintenance of the application content at the application server 12. This also enables multiple endpoint types 16 to receive a similar user experience, regardless of the platform. For example, a centrally managed endpoint application can be deployed on Apple, Blackberry, and Palm devices without having to separately develop an application for each platform.

As shown in FIG. 1, communications between the endpoints 14 and the application server 12 are facilitated by connectivity over the Internet or other suitable network 15 as is well known in the art. Similarly communications between the application 12 and the CMSs 20 are facilitated by connectivity over the Internet or other suitable network 22. It can be appreciated that the networks 15, 22 can be the same or different. For example, the network 15 may be a wireless network, whereas the network 22 may be a wireline service or hybrid of the two. Also, future networks may employ different standards and the principles discussed herein are applicable to any data communications medium or standard.

The application server 12 may provide its own CMS services (e.g. by incorporating CMS 20′) or may otherwise enable direct interactions with developers 26′ and administrators (Admin) 28′, e.g. through a browser 30 connectable to the application server 12 through the Internet or other suitable network 32. In this way, the application server 12 can service individuals that do not necessarily rely on or require the capabilities of a CMS 20. Similarly, admin 28′ may be required to service the applications deployed and managed by the application server 12 or to service and maintain the application server 12 itself.

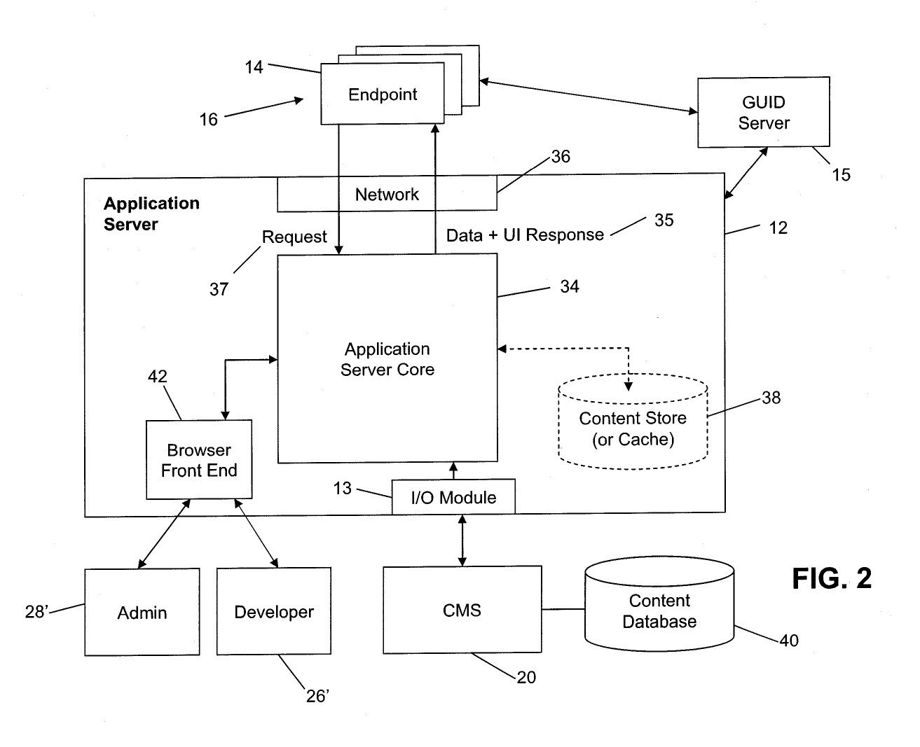

Further detail of one configuration for the application server 12 is shown in FIG. 2. The application server 12 in this configuration has a network component 36 providing an interface between an application server core 34 and the various endpoints 14 and endpoint types 16. This allows the application server core 34 to receive content and data requests 37 from the endpoints 14 and to return data and UI responses 35 thereto. The application server 12 also comprises a browser front end 42 which enables the admin 28′ and developers 26′ to interact with the application server core 34. Alternatively, any other application programming interface (API) (not shown) can be used to provide a portal into the application server core 34 to users with the appropriate permissions. In this example, when relying on a CMS 20, the application server 12 may obtain content and other data from the CMS 20, through the I/O module 13, wherein the CMS 20 stores such content and data in a content database 40. Alternatively, or in addition to, the application sever 12 may have its own content store 38. In yet another alternative, the application server 12 may have a content cache 38 that temporarily stores content to avoid repeated requests to the CMS 20 for the same content.

FIG. 2 also illustrates a global unique identifier (GUID) server 15. As will be discussed further below, each instance of an application on an endpoint 14 can be given an ID (GUID). Each application may thus be assigned a GUID when it makes is first (initial) request to the endpoint application server 12. The GUID server 15 can be used to prevent two instances (even with the same name) having a conflict on the endpoint 14. For example, data storage on the endpoint 14 can be indexed by GUID such that each application can be assured that its data store belongs only to itself and no other application. This can isolate each application from one another and also allow the application server 12 to identify each endpoint application as it makes a request and allow for analytical tracking such as usage, advertising statistics, etc. The GUID server 15 can be an external server as shown in FIG. 2 and can be made responsible for generating GUIDs to manage and distribute GUIDs to endpoints 14. This configuration can be used to ensure that all GUIDs for all endpoint applications are generated from the same server. In other words, the GUID server 15 can be used as a certification server whose responsibility is to verify if an endpoint application is valid and accordingly generate GUIDs. This creates a central “control hub” for managing all endpoint applications.

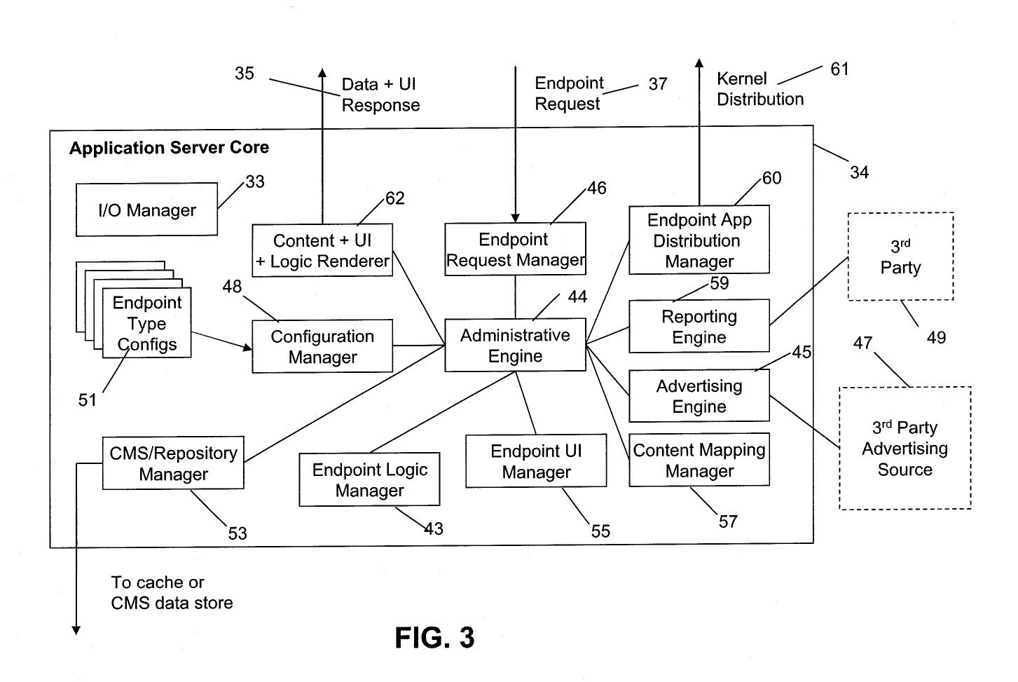

Turning now to FIG. 3, an exemplary configuration for the application server core 34 is shown. The server core 34 comprises an administrative engine 44, which is responsible for handling requests 37, obtaining the necessary content/UI/logic, definitions, configurations and other data, and providing responses 35. The administrative engine 44 uses an endpoint request manager 46 to manage incoming requests 37 from the endpoints 14 to determine what kind of endpoint 14 is making the request 37. Once it knows the endpoint type 16, the administrative engine 44 then uses the configuration manager 48 to get the necessary configuration 51 for that endpoint type 16. The CMS/repository manager 53 is then called to obtain content or data from the source 21, CMS 20, etc. The content is then combined with the associated logic obtained by an endpoint logic manager 43 and combined with the associated UI definitions obtained by an endpoint UI manager 55 and the content is mapped using a content mapping manager 57. The content mapping manager is used in situations where the CMS 20 or the source 21 is not an integral part of the application server 12 such that external data and content types can be mapped to content items used in the application server 12. This is particularly important where external sources 21 or CMSs 20 use data or a format that is not familiar or regularly used in the application server 12. The content mapping manager 57 can thus be used to translate external data to a format common to the application server 12. The endpoint UI manager 55 is used to determine what kind of UI “view” definitions should be loaded given the content being requested and the endpoint type 16 of the requestor. A reporting engine 59 may also be used, in conjunction with a 3^{rd} party entity 49 (if applicable) to keep track of analytical data sent from the endpoint 14 and generate usage reports from data provided in the request 37.

The content+UI+logic (and report if applicable) is then passed to a content+UI+logic renderer 62 to generate a data package to be sent back as a response 35 as will be explained in greater detail below. An advertising engine 45 may also be called where appropriate to add advertising content, e.g. obtained from a 3^{rd} party advertising source 47 (if applicable). An I/O manager 33 may also be used, e.g. where data and content provided by the CMS 20 or source 21 needs to be translated or converted at the server side. An endpoint application distribution manager 60 is also provided for managing the distribution of kernel logic 61 for installing a runtime module 18 on the various endpoints 14.

The administrative engine 44 therefore gathers the necessary configurations and mappings as well as the content and data itself for the particular endpoint application, and provides these components to the renderer 62 to generate a suitable response 35 for the requesting endpoint 14.

FIG. 4A illustrates additional detail of one configuration for a CMS 20. As noted above, the CMS 20 may use a plug-in 24 to enable the application server 12 to communicate with the CMS platform 64 to avoid having to reconfigure or re-program the CMS 20. It will be appreciated that the plug-in 24 is typically a piece of custom code that would be written to make non-compatible CMSs 20 and sources 21 work with the application server 12. As shown in FIG. 4A, the CMS 20 may utilize the plug-in 24 in some embodiments, but may instead provide its native data directly to the application server 12 to be converted or translated by the I/O module 13. In other configurations, e.g. when the CMS 20 is integral to the application server 12, a familiar format of data/content can be sent directly to the application server core 34 without requiring any translation. It may be noted that the plug-in 24 is particularly advantageous for unlocking content or data that is held by an otherwise isolated source 21. For example, a vehicle may provide data that can be used for a traffic application and the plug-in 24 can be written to enable that data to be provided to the application server 12. Also, in the CMS environment, the plug-in 24 can be written to provide a transparent interface with the application server 12 such that the CMS 20 does not need major re-programming to deploy endpoint applications.

The CMS platform 64 in this example represents any existing capabilities and functionality provided by the CMS 20, e.g. for content management, content development, content storage, etc. Accordingly, one or more connections to an existing infrastructure may exist, e.g. for deploying web-based solutions to browsers 66. The CMS platform 64 receives various inputs that allow users to create, manage, and store content in the content database 40 in a way that is familiar to them, but also through the plug-in 24 enables endpoint applications to be created, deployed, and managed through the application server 12.

FIG. 4B illustrates further detail of a source 21 and in the same way as for the CMS 20, the source 21 can utilize a plug-in 24, rely on the I/O module 13 or, in other circumstances, provide its native content/data which is already in the proper format for the application server 12. A content or data source or repository platform 64′ may represent any existing infrastructure such as a server that feeds or stores (or both) data to the network 22. For example, a news service that is already deployed for feeding news stories to multiple news providers (e.g. newspapers) could be accessed to utilize in a endpoint application that can be viewed on multiple platforms using the application server 12.

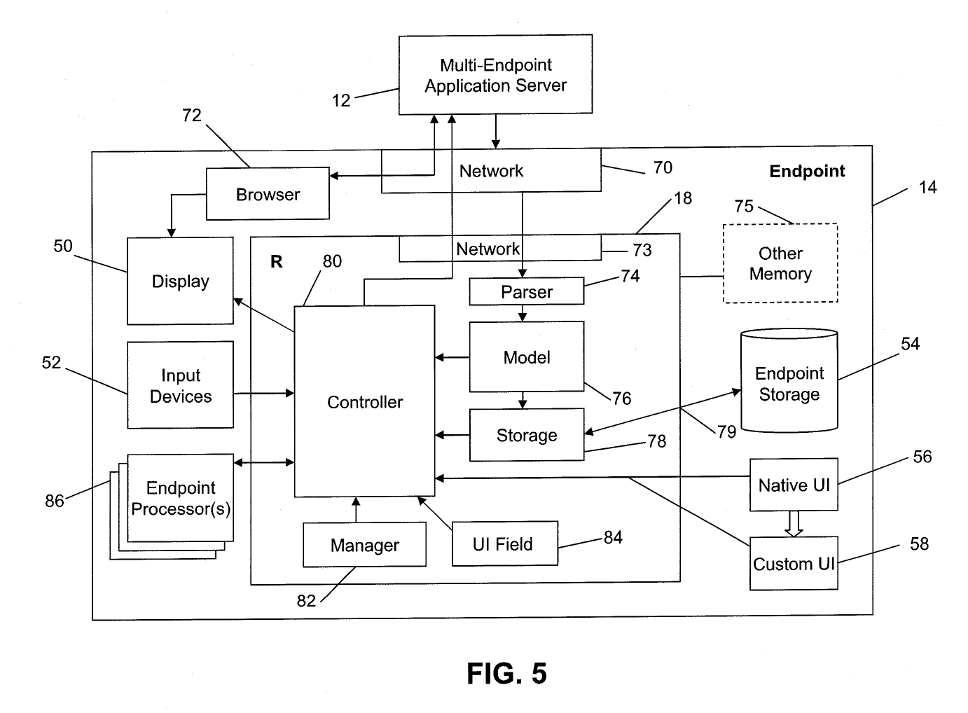

Turning now to FIG. 5, further detail of an example endpoint 14 is shown. The endpoint 14 in this example is meant to represent a general computing device that is capable of running an application, typically a endpoint application. The endpoint 14 shown comprises a network component 70 for connecting to the application server 12 through the network 15, and may also have a browser 72 for running web-based applications. In general, the endpoint may utilize a display 50, various input devices 52 (e.g. touch-screen, trackball, pointing device, track wheel, stylus, keyboard, convenience keys, etc.), and have one or more of its own processors 86. The endpoint 14 also typically has its own memory or data storage 54, which can include any suitable memory type as is well known in the art. Other memory 75 such as flash memory, removable storage media, etc. can also be available or included in the endpoint 14 depending on the endpoint type 16. The endpoint 14 typically also has native UI 56 and custom UI 58 extending or “building” from the native UI 56 to utilize the features made available by the endpoint 14 when applicable.

In order to implement a endpoint application managed by the application server 12, the endpoint 14 comprises a runtime module 18 for each mobile application. The runtime module 18, as will be discussed below, comprises kernel logic 98 and application logic 100 for the corresponding mobile application. This can be done to ensure that each application on the endpoint 14 has its own kernel meaning that each kernel+application is protected in its own application space and is isolated from errors and crashes that may happen in other applications.

The runtime module 18 comprises a network layer 73 to interface with the network component 70 in the endpoint 14, and a parser 74 in communication with the network layer 73, which is invoked upon receiving a response 35 from the application server 12 to begin processing the incoming data. The network layer 73 handles responses 37, reads data, and sends the data to the parser layer 74. The parser layer 74 parses the incoming data and converts the data into in-memory objects (data structures), which can then be grouped into collections and managed by the storage layer 78 and other internal subsystems. The parser layer 74 uses a model layer 76 to create models. Models are the logical definitions of the data structures, which define classes that the runtime module 18 uses to internally represent views, content, and data. The grouping into collections can be handled by collection classes (not shown) and there is typically a specific collection class for each model type. For example, a theme model can be grouped into a ThemeCollection class, which in turn is stored on the endpoint 14 via the ThemeStore class. The model layer 76 uses a storage layer 78 to persist the model. The storage layer 78 works with the model layer 76, inherits collections, and acts as a broker between the model layer 76 and the endpoint storage 54. The storage layer 78 is responsible for encoding and decoding the models into a format that is appropriate for the hardware storage that is present on the endpoint 14. As can be seen in FIG. 5, there is a data persistence pathway 79 between the storage layer 78 and the endpoint storage 54, which transports the raw models in a format (e.g. persistent or binary) for storage in the endpoint 14. The runtime module 18 also comprises a controller 80 for generating requests 37 according to user inputs and the overall operation of the corresponding endpoint application. The controller 80 uses a manager 82 for providing screen layout functionality to the controller 80, and a UI field 84 which represents classes the controller 80 uses to place items within the manager 82 to create a “screen”.

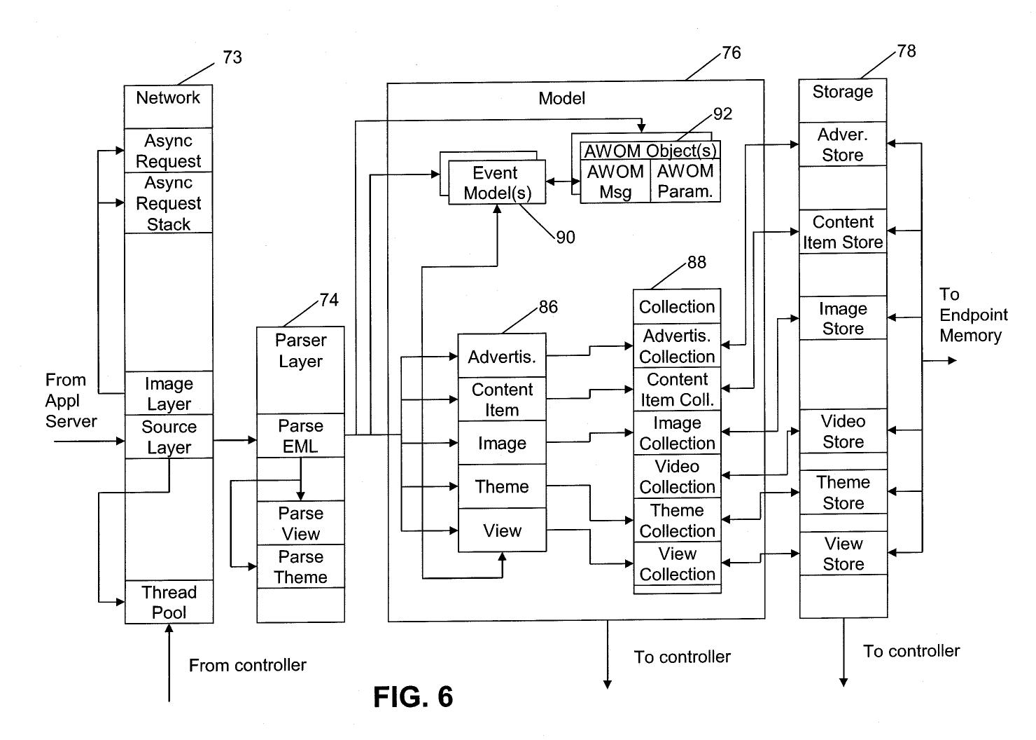

Further detail of the network layer 73, parser layer 74, model layer 76, and storage layer 78, is shown in FIG. 6. The network layer 73 is responsible for making requests to the application server 12 and for fetching images and resources from remote locations. The content and data is received at a source layer and placed in a thread pool to be retrieved by the controller 80. An image layer makes asynchronous requests so that the runtime module 18 does not need to wait for everything to be received before it begins displaying items. The parser layer 74 is responsible for taking data in EML format, process this data, and convert the data into internal data structures in memory. The parser layer 74 parses the EML content, parses the views, and parses the themes (defined in the EML) to separate advertising, content item, image, theme and view classes 86 that are then loaded into corresponding collections 88 in the model layer 76. The parser layer 74 also extracts application wide objective messaging (AWOM) objects 92 which are associated with one or more event model types, e.g. a UI model such as a button click, a background event such as an automatic update, etc. The model layer 76 is the data structure definition used internally by the runtime module 18 to represent all content/view/theme information. The view model is a child of a UI type event model 90 which is an abstract definition that indicates what belongs in each item for a screen. The event models 90 can enable objective messaging by utilizing AWOM objects 92. The AWOM objects 92 comprise AWOM messages and parameters. Further detail of AWOM is provided below. The collections 88 are then stored using the storage layer 78 and persisted in the endpoint storage 54. The storage layer 54 is responsible for taking the models in the collection form and storing and retrieving them locally on the endpoint 14 and passing the collections to the controller 80 to generate a screen.

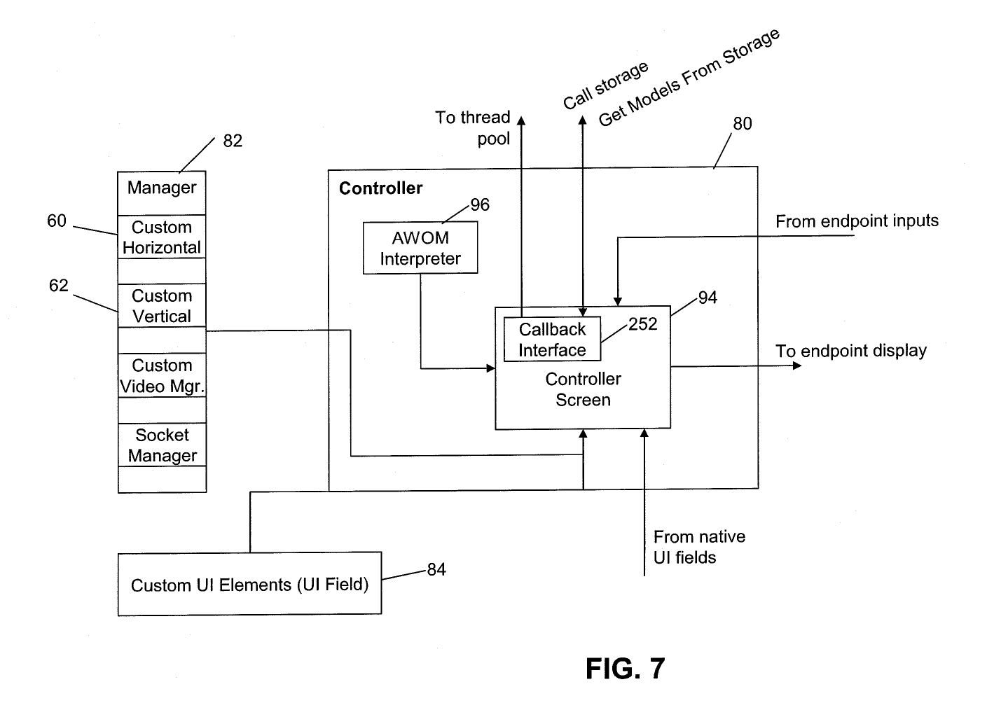

Turning now to FIG. 7, further detail of the manager 82, custom UI elements 84 and controller 80 is shown. The controller 80 comprises a controller screen module 94 for interpreting user inputs and model and storage layer components to generate an output for the endpoint display 50. The controller screen 94 uses an AWOM interpreter 96 for parsing AWOM messages as they are received and executing the appropriate code based on the message. The controller 80 also uses a callback interface 252 to make asynchronous requests to the thread pool and calls storage layer 78 to obtain models from storage once the items are received. In other words, the callback interface 252 monitors the threads to determine when the content or data is available and uses the storage layer 78 to obtain the content or data for incorporation into the screen. The controller 80 may also rely on custom UI elements 84 to leverage the native UI while providing custom look-and-feel.

As can be seen in FIGS. 6 and 7, AWOM components are utilized to dynamically generate code that will execute on the endpoint 14 to respond to interactivity with the endpoint application. The AWOM technique involves sending object oriented messages to the runtime module 18, which are then parsed and interpreted into native platform instructions. An endpoint 14 can also generate AWOM code and send this to the application server 12 for processing. The use of the AWOM messages enables the endpoint application to be deployed to and utilize the functionality of multiple endpoint types 16 without custom programming for each endpoint type 16.

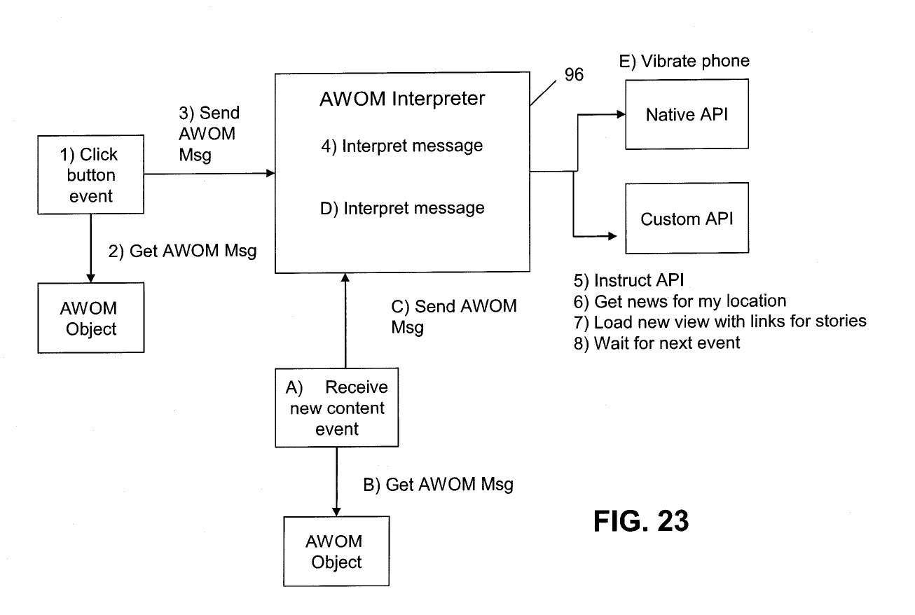

Turning now to FIG. 23, the use of AWOM messages in response to example events is shown. One example illustrated in steps 1) through 8) relates to a UI event wherein a button is clicked at step 1) which causes the event model 90 for that button to access its associated AWOM object 92 at step 2) to determine the AWOM message for that event. At step 3), the AWOM message is sent to the AWOM interpreter 96 in the controller 80, which interprets the message at step 4) to instruct the custom API in this example at step 5) to get news for the current location of the endpoint 14 (e.g. using a custom API developed from native API for a GPS program) at step 6), load a new view at step 7) that includes links to the news stories, and then waits for the next event at step 8), which may include a link selection event, etc. It can therefore be appreciated that each event has an AWOM object 92 associated therewith that enables the appropriate AWOM message to be sent to the AWOM interpreter 96. The AWOM interpreter may then interpret the message and then hands over operations to the API, either native or custom or both to then perform the selected operations.

It can be appreciated that the events can be any possible event associated with the endpoint application. For example, steps A) through E) illustrate an event that is not linked to a user action. In this example, new content that is automatically provided to the endpoint 14 is received at step A), which invokes a new content event, which in turn causes the event to access the associated AWOM object to obtain the AWOM message at step B). The AWOM message, as before, is sent to the AWOM interpreter, which then instructs native API to vibrate the phone to notify the user that new content is available. As such, it can be appreciated that AWOM provides a flexible solution to handle both user driven events and non-user driven events to handle interactivity associated with the endpoint application. The EML document enables the static structures to be defined and the AWOM objects 92 handle dynamic events to update or load new views, etc.

This solution allows a great deal of flexibility between client and server and the format provided by way of example below uses objective messaging which can be embedded inside EML specifications.

In this example, there are three aspects to the AWOM protocol, namely API reference, action reference, and parameter list by name. The API reference denotes the target API related to the message. The following formats can be used:

[APIName]—enables the message to be routed to the API specified.

[@all]—enables the message to be delivered to all APIs registered with the AWOM interface. Generally this kind of a call would be used in a system wide shutdown or events that affect all (or most) aspects of the application.

[@this]—enables the message to be routed to the API of the caller. For example, if the caller is a button field, the message would be routed to the calling button or handling.

[@field_{—}12]—denotes that the message should be routed to the API of the field with the ID=12 (in this example).

The action reference denotes the action that should be taken on the target API. The action should be denoted by the name of the action, i.e. doSomething. The Parameter list by name specifies a list of parameters to pass with the action. This aspect can use any suitable delimiter and in this example uses a colon-delimiter, i.e. paramA=‘1’: paramB=‘2’.

To send a message to all registered AWOM APIs to record their usage statistics, the following message can be used: [@all persistAnalytics];. To load a new view to the device display, the call may look like the following: [ViewLoader loadView: id=‘02347’];. To make a callback function call, i.e. to indicate that you want the caller object to invoke API in its own instance, the following message could be used: [@this update Title:text=‘Updated Title’:fontStyle=‘bold’]. To make nested calls, the following message provides an example of how to do so: [@this updateTitle:text=[DataStore getUsername: userID=‘123’]];.

An example script notation is shown below:

<$pscript

[Package setname=’wi.prism.test];
[Importer load:libName=”wi.prism.ajax.system1”];
[Importer load:libName=”wi.prism.ajax.system2”;]
[DataStorage writeUsername:[Profile getUsername: ”00002”]];
[Meta setAppType:”1”];
[ContentItem create:”1000”];
[Set name:”oContentItem”:[ContentItem create:”1000”]];
[Set name:”global.x”:”5”];
[Revision getRevision: [Get name: “oContentItem”]];
[Set name: “content”:[PrismFile readFile: “dcd.txt”:”R;WD”]];

$>

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the endpoint 14 or accessible or connectable thereto. Any application or module herein described may be implemented using computer readable/executable instructions that may be stored or otherwise held by such computer readable media.

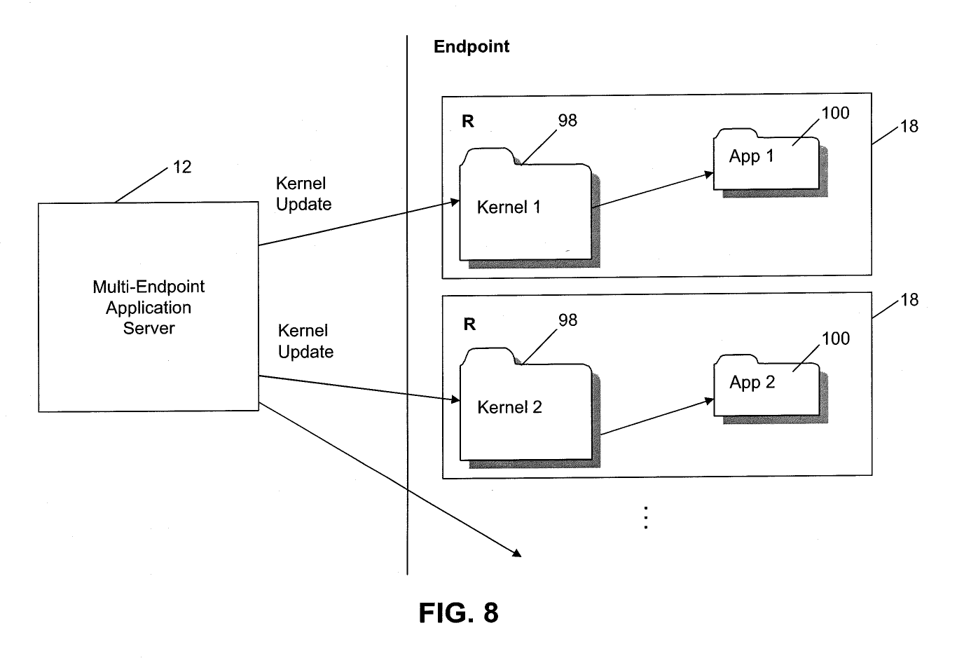

Turning now to FIG. 8, the separation of kernel 98+application 100 into separate runtime modules 18 is shown. As noted above, each application 100 has its own kernel to protect each application from errors and crashes in other applications 100. Also, each kernel 98 can be separately updated without affecting the operation of other applications 100. With each request 37, the endpoint application 14 can send the kernel version number in the body of the request 37 (not shown). The application server 12 can then compare the kernel version with the latest kernel version number (for that endpoint type 16) currently residing on the application server 12. If the versions do not match, for example if the endpoint kernel 98 is out of date, the application server 12 can respond back with information that instructs the kernel 98 on the endpoint 14 to update itself from a given uniform resource identifier (URI) (if possible) or to request a 3^{rd} party application store to update its software. For updating the actual application 100, since an application's UI/Logic/Styling/content is all defined by the application server 12, a server administrator can simply create/update the UI or content items on the server side. On the device side, once the endpoint 14 makes a request 37 for the content, it would automatically get updated UI/Styling (themes) from the application server 12.

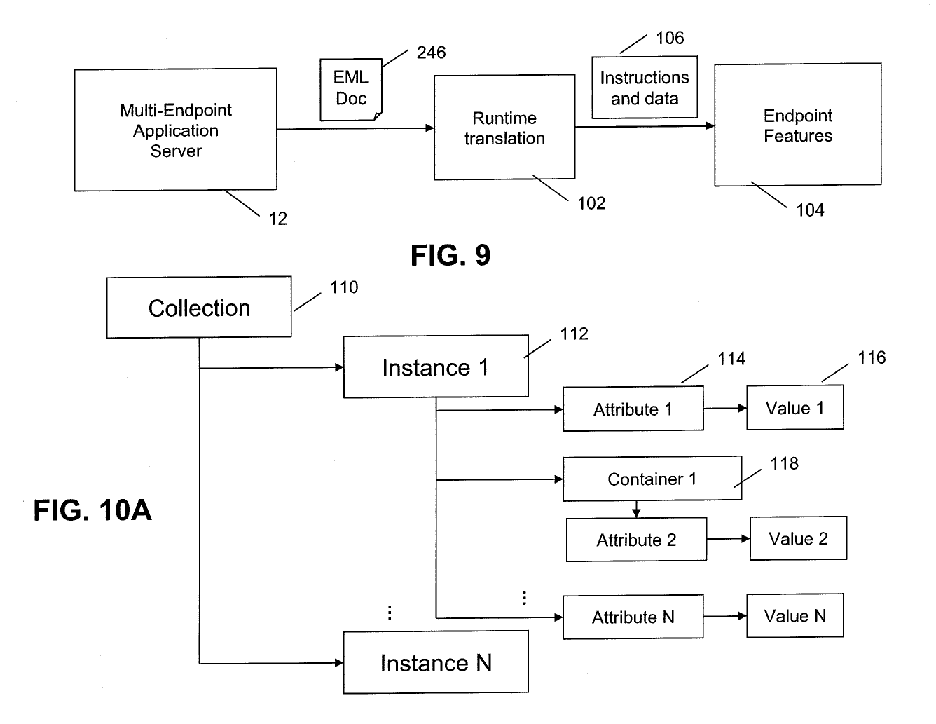

As shown in FIG. 9, in order to enable a single endpoint application to be developed and maintained while being deployed on multiple endpoints 14 and multiple endpoint types 16, the application server 12 generates a set of data, hereinafter referred to as a EML document 246, that can be interpreted in a runtime translation 102 (i.e. using the runtime module 18), to generate instructions and data 106 to be used by various endpoint features 104. For example, a EML document 246 may include the content and UI data for playing a game on a particular one of various smart phone platforms, which is translated into instructions and UI content for showing game play on the smart phone display and using user inputs to participate in the game.

In order to enable such translations to occur on multiple endpoint types 16, a programming language can be used, for example EML as described herein. A UI schematic can be developed that utilizes EML to allow a given CMS 20 (or developer 26) the flexibility of controlling the look-and-feel of a client endpoint application. EML is based on a structure similar to XML but adapted for the application server 12 and runtime modules 18. To enable extensive UI customization from endpoint-to-endpoint, the application UI scope and content UI scope should be defined.

The application UI scope refers to how an application will flow from screen-to-screen, the overall design theme, the layout structure, and screen definitions. In general, this defines the UI feel of the particular endpoint 14.

An overall design theme refers to how the application will look aesthetically. This can include definitions for header colours, banner images, outline styles, text font, title font, etc. View definitions may be needed in order to define the various views and contain sockets that can be reused to display various forms of content. The screen-to-screen-flow refers to how the navigation system functions. The EML defines or refers to pre-existing navigation styles. For example, this could mean carousel navigation, menu navigation, etc.

The overall design theme, view definitions, and screen-to-screen flow of the application UI scope will be referred to below in the context of the content UI scope to create a cohesive user experience.

The content UI scope comprises the definition of each content item and how it should be displayed relative to the application UI scope. This will not necessarily alter the application's overall look-and-feel, but rather should only affect the content item currently being displayed. However, the content UI scope may make references to items defined in the application UI scope such as screen definitions and the sockets contained within them. Therefore, the purpose of the content UI scope is to place a given content item within the application UI scope context.

The EML should also have the ability to bind data to UI elements, namely UI elements as defined in the EML do not necessarily have to have their display values assigned, the EML should be flexible enough to allow the runtime module 18 to assign these values dynamically. Also, similar to any UI, user events need to be handled. A user event may represent many actions such as click events on buttons, focus events, etc. Therefore, the EML schema should provide the user with some logical way of detecting these events and reacting appropriately.

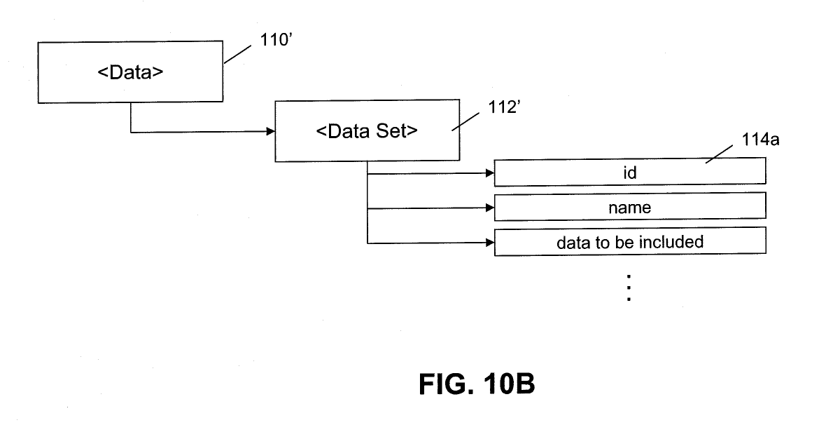

The EML schema may be described making reference to FIGS. 10-18. FIG. 10A shows a generalized breakdown of a hierarchy that can be followed to define various collections 110, such as themes and views. As shown in FIG. 10A, each collection 110 may have zero or more instances 112 and each instance may have zero or more attributes 114 each having an associated value 116 in most cases. Various groupings of attributes 114 can be made within a container 118, which is also under an instance 112 of that collection 110. Within the application UI scope, one collection 110 is themes. The theme definition is what defines the overall style of the application. In the theme definition, the CMS 20 or developer 26 can manipulate the colour scheme, fonts, borders, backgrounds, etc. that will be present throughout the entire application. In addition, styles can be set for individual UI types such as buttons, labels, etc. by referring to these themes.

It has been recognized that the EML format herein described can also advantageously be expanded to provide more generally a data carrier and should not be limited to defining UI elements. As shown in FIG. 10B, <Data> is the parent node defining a collection 110′ of data sets and <data set> is used to define an individual instance 112′ of a data set. In this example, various attributes 114′ are shown, including an id, name, and data to be included. It can be appreciated that the attributes may vary according to the data being carried in the EML format and may include only the data itself.

By enabling arbitrary data to be defined using the EML format, the EML format can thus be extended such that it can both start with text and build up to define a UI and start from elements defined in such arbitrary data and break down to provide more complex UI configurations such as those including timed events, drop down menus. In other words, the EML format provides both mark-up capabilities and construction from top down. The EML format can therefore act as the carrier of both UI mark-up and data for the endpoint application. In other words, the EML can not only define how the endpoint application looks, but also define what data the endpoint application can present (e.g. Listing of local pizza stores, the way it displays the listing is defined in the UI mark-up, and the actual data representing various pizza stores is defined in the <Data> portion).

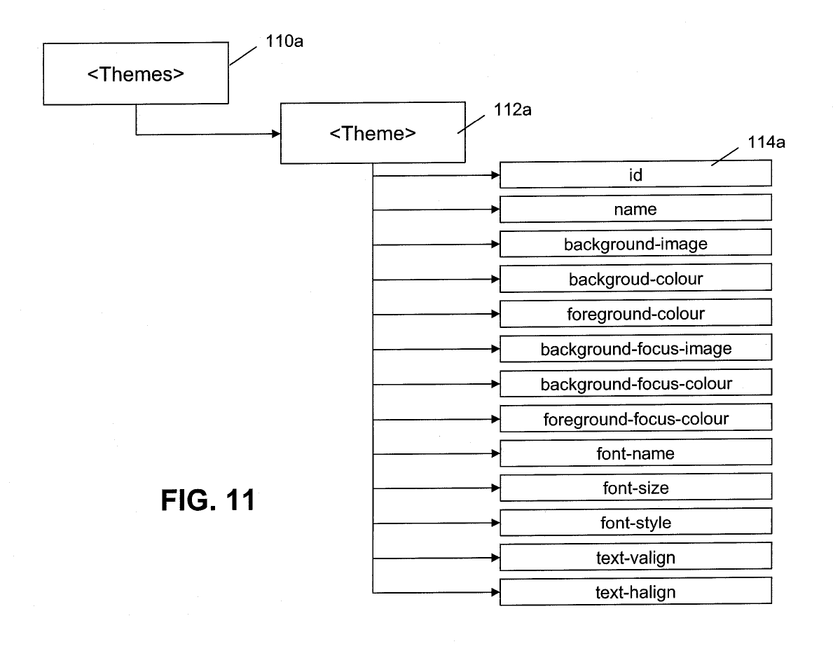

An exemplary theme instance 112 is shown in FIG. 11. In this structure, <themes> is the parent node defining a collection 110a of themes, and <theme> is used to define an individual instance 112a of a theme. Various attributes 114a are shown and can be described as follows: id—assigns an identifier value to the theme; name—provides a name for the theme; background-image—the identifier for the background image to use; background-colour—a code (e.g. hexadecimal) for the background colour; foreground-colour—a code (e.g. hexadecimal) for the foreground colour; background-focus-image—the identifier for the background image to use for focus; background-focus-colour—a code (e.g. hexadecimal) for the background colour to use for focus; foreground-focus-image—a code (e.g. hexadecimal) for the background colour to use for focus; font-name—the name of the font to use; font-size—the size of the font to use; font-style—the font style, e.g. bold, underline, italics; text-valign—the vertical alignment of the text, e.g. top, bottom, centered; and text-halign—the horizontal alignment of the text, e.g. left, right, centered.

Example syntax for a collection of themes is as follows:

<Themes>

| | |
|---|---|
| <Theme | id = “1” |

| | name = “button_theme_test“ |
|---|---|
| | background-image = “2” |
| | background-colour = “0000F0” |
| | foreground-colour = “FFFF0F” |
| | background-focus-image = “2” |
| | background-focus-colour = “1111F1” |
| | foreground-focus-colour = “FFFF1F” |
| | font-name = “Arial” |
| | font-size = “12” |
| | font-style = “I/B” |
| | text-valign = “T” |
| | text-halign = “C”/> |
| <Theme id = “2” | |
| | name = “list_theme_test” |
| | background-image = “2” |
| | background-colour = “0000F0” |
| | foreground-colour = “FFFF0F” |
| | background-focus-image = “2” |
| | background-focus-colour = “1111F1” |
| | foreground-focus-colour = “FFFF1F” |
| | font-name = “Arial” |
| | font-size = “12” |
| | font-style = “I/B” |
| | text-valign = “T” |
| | text-halign = “C”/> |
| </Themes> | |

It may be noted that the EML format for themes has been adapted from XML to be similar to CSS syntax.

View definitions define the various screens or “views” that the endpoint application will be able to display. A view definition contains structural information about the relevant screen, such as layout information, meta information such as title, etc. UI elements can be assigned actions and values dynamically via AWOM described above.

An exemplary view instance 112b is shown in FIG. 11. In this structure, <views> is the parent node defining a collection 110b of views, and <view> is used to define an individual instance 112b of a view. Various attributes 114b and a pair of containers 118b are shown and can be described as follows: id—the identifier for the view; title—a title for the view; <HPanel>; and <Vpanel>. A panel generally defines a logical and visual container that holds UI fields, in this case in a horizontal manner and vertical manner respectively. Each panel comprises a number of attributes 14b, namely: id—an id for the panel; height—ranges from 0.0 (0%) to 1.0 (100%), defines the percentage of screen height to use; width—ranges from 0.0 (0%) to 1.0 (100%), defines the percentage of screen width to use; themeId—to give the panel a custom look, a theme can be assigned, otherwise this can be left blank or themes assigned manually; and spacing—the amount of horizontal/vertical spacing between items within the panel, typically measured in pixels.

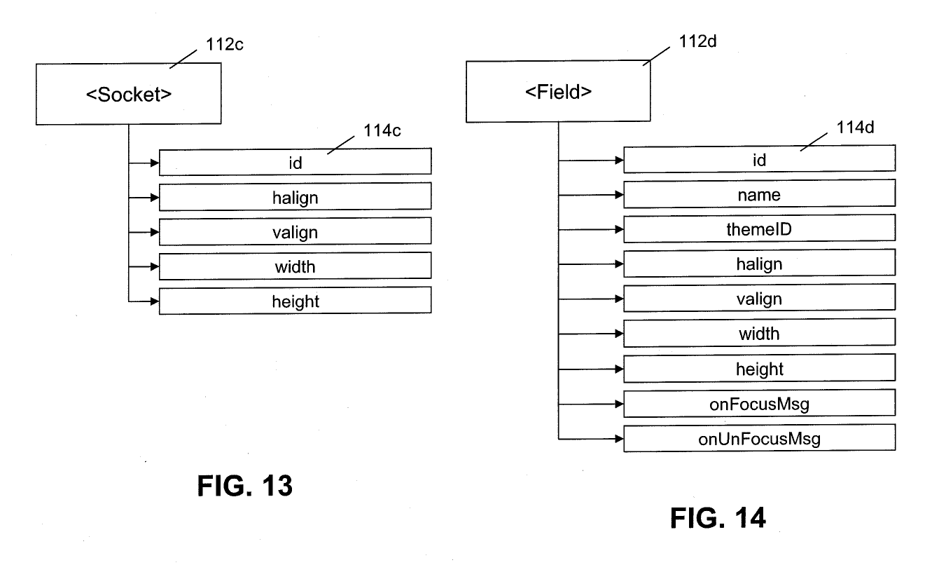

Various other components within a view may be defined, such as sockets, and field structures as shown in FIGS. 13-17. FIG. 13 shows a socket instance 112c, which defines a pluggable socket within a view. Similar to the above, the socket comprises the following attributes, explained above: id, halign, valign, width, and height.

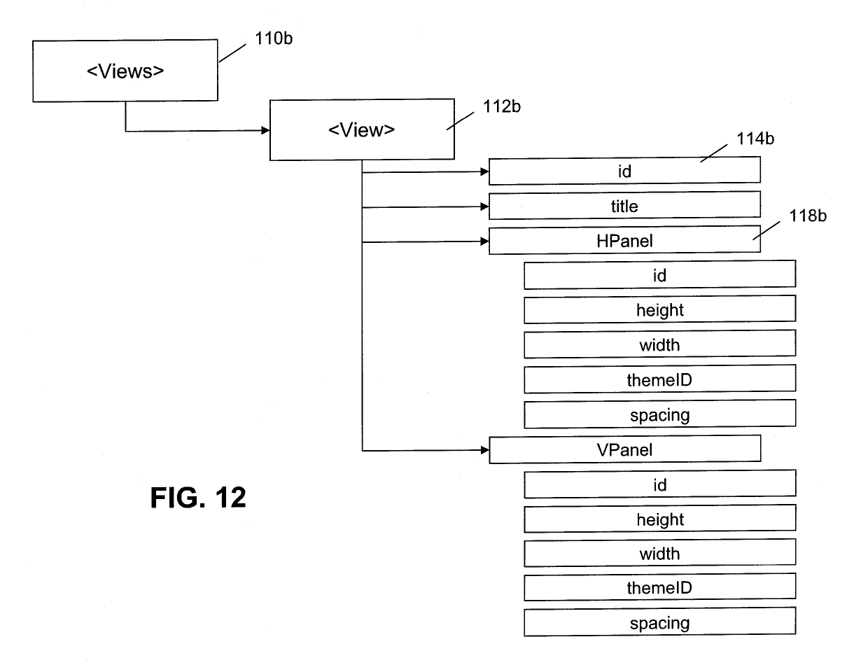

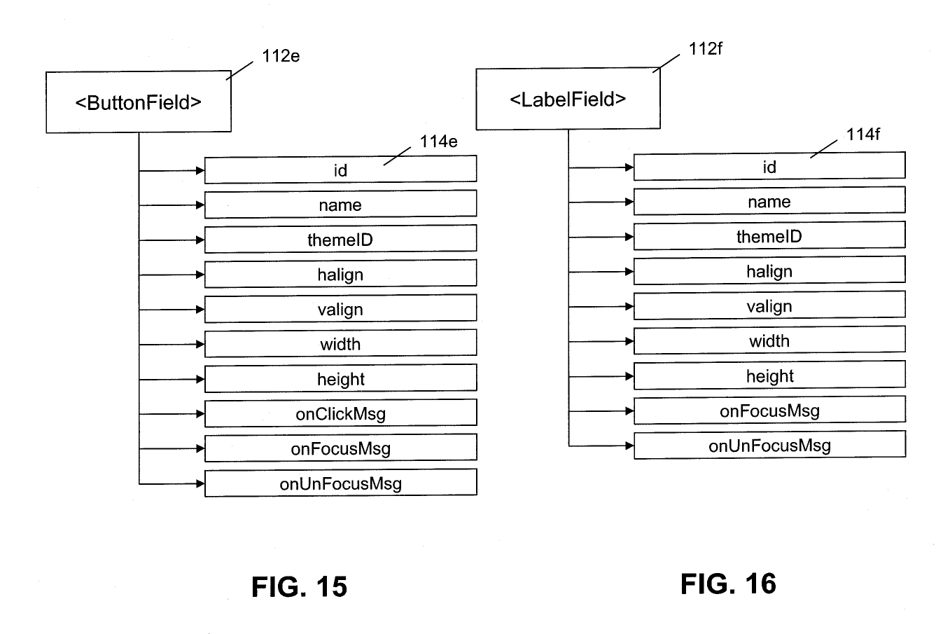

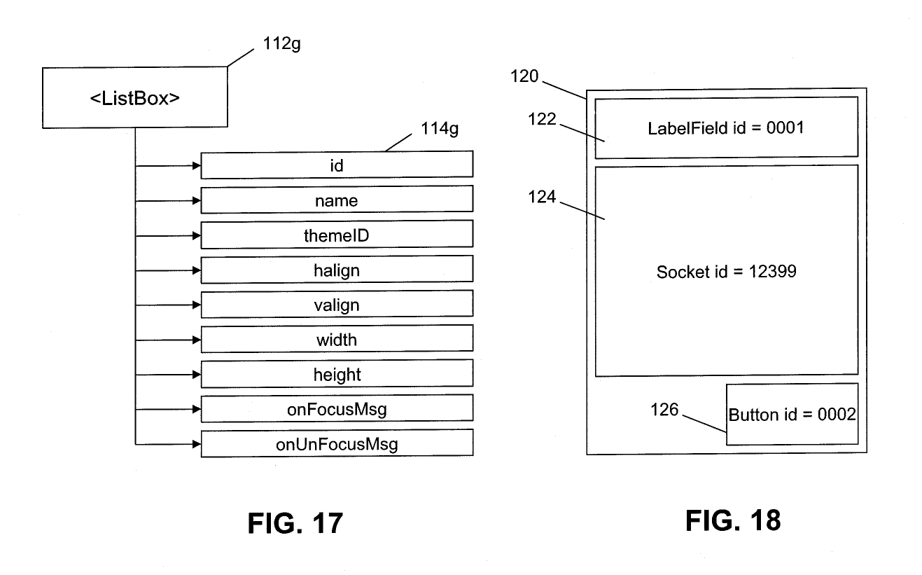

FIG. 14 shows a field instance 112d, comprising the following attributes: id, name, themeId, halign, valign, width, height, on FocusMsg, and on UnFocusMsg. The on FocusMsg attribute is an AWOM message that is sent when the field gets the focus, and the on UnFocusMsg is an AWOM message that is sent when the field loses focus. As can be seen in FIGS. 16 and 17, the labelField instance 112f and ListBox instance 112g include the same attributes 114f, 114g, as the field instance 112d. FIG. 15 illustrates a ButtonField instance 112e, which includes the same attributes 114e as the Field instance 112d, with an additional attribute 114e, namely the OnClickMsg, which is an AWOM message that is sent when the button is clicked. It can be appreciated that other attributes 114 and instances 112 can be defined depending on the application and the platforms on which it may operate, and those shown in FIGS. 12-17 are for illustrative purposes only.

Exemplary syntax for a view instance 112b is shown below:

<Views>

<View id = “0001” title = “article_list”>

<VPanel id = “01” height = “1.0” themeId = “001” spacing = “1” >

<LabelField id = “0001” name = “label1” themeId = “002” width =

“1.0” height = “.25” onFocusMsg = “[@this hasFocus]; ”

onUnFocusMsg = “[@this lostFocus];” valign = “T” halign = “L”>

Hello World!

</LabelField>

<Socket id = “12399” width = “1.0” height = “.5” valign = “T” halign

= “L”/>

<ButtonField id = “0002” name = “button1” themeId = “003”

width = 0.5” height = “.25” onFocusMsg = “[@this hasFocus];”

onUnFocusMsg = “[@this lostFocus];” onClickMsg = “ [ViewLoader

loadView: id = ‘0001’];” valign = “B” halign = “R”>

Click Me!

</ButtonField>

<VPanel>

</View>

</Views>

The output layout view for the above example is shown in FIG. 18. As can be seen in FIG. 18, a display area 120 comprises a label 122, a socket 124, and a button 126.

The content UI scope defines the basic properties of a content item, along with its display styles and settings. The content UI scope can also define where within the application UI scope the content item fits, via Views and Sockets. Data binding can also be assigned in the content UI scope if some of the field values need to be determined at runtime. Exemplary syntax for the content UI scope to achieve the example layout shown in FIG. 18 is provided below:

<ConentItems>

<Content id = “56465” viewId = “0001” socketId = “12399”
onLoadMsg =

“[@thissetTitle: title = ‘test title’];”>

...Context Text / Revision Content... Can reuse fields and themes

here as well...

</Content>

</ContentItems>

It can be seen that the content UI scope enables various views, sockets and fields to be arranged together to define the ultimate output. Data binding can also be used here through the viewID and socketID attributes of the content element. The viewID defines in which view the content should be placed, and the socketID defines where inside the view this content should be located.

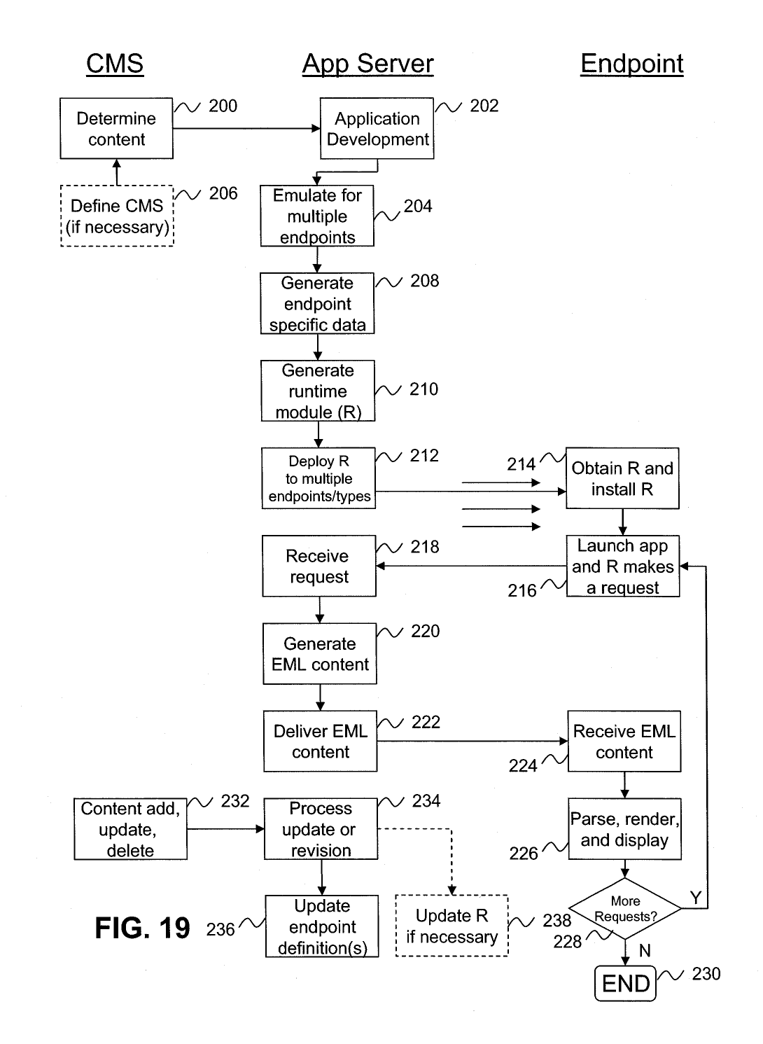

FIG. 19 illustrates an exemplary set of computer executable instructions showing the development, deployment, use and management of a endpoint application. In this example, content for the endpoint application is provided by or otherwise determined using the CMS 20 at step 200 and, if necessary, the CMS defined at step 206 to enable future extraction and management of content for the endpoint application. For example, a developer may use the CMS 20 to extract and provide various data and content to the application server 12. It will be appreciated that the example shown in FIG. 19 is equally applicable to any source 21 and should not be limited to CMSs 20 only. At the application server 12, the endpoint application is developed at step 202, and this may be done in conjunction with the CMS 20 or separately therefrom as noted above. In this example, it is assumed that upon beginning development of the endpoint application, runtime modules 18 for several platforms will be defined. In such a situation, the developer 26 can emulate for multiple endpoint types 16 at step 204 thus generating endpoint-specific data at step 208 for such multiple endpoint types 16.

At step 210, runtime modules 18 are generated and they can then be deployed to the multiple endpoints 14 and endpoint types 16 at step 212. In FIG. 19, operations from the perspective of one endpoint 14 are shown. At the endpoint 14 the newly developed runtime module 18 is obtained and installed at step 14 (which would be done at other endpoints 14 and other endpoint types 16). At step 216, the application may be launched and the runtime module 18 invoked to make a request 37 for content in order to enable the user to use the endpoint application. The application server 12 then receives the request 37 at step 218 and generates EML content at step 220 (explained further below). As discussed above and shown in FIG. 9, this may include generation of an EML document 246. The EML content is then returned to the endpoint 14 that made the request 37 at step 222, and the endpoint 14 receives the EML content in a response 35 at step 224. The EML content is then parsed, rendered, and displayed in the endpoint application at step 226, and while the endpoint application is being used, the endpoint 14 determines if more requests 37 need to be generated at step 228. If not, the runtime module 18 ends at step 230. If more requests 37 are required, e.g. to dynamically obtain or provide information generated as a result of using the endpoint application, steps 216 to 228 can be repeated.

Either dynamically or at some other time, the content in or provided by the CMS 20 can be added to, updated, deleted, etc. at step 232. This can then trigger a process for updating or revising the content and data, the endpoint application definitions, or both at step 234. If necessary, the runtime module 18 may be updated at step 238, and the endpoint definitions or associated content updated at step 236.

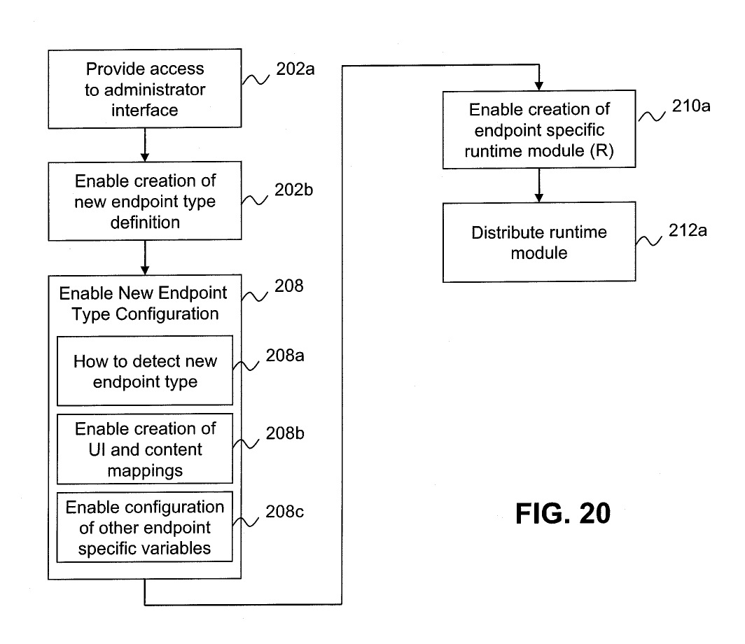

Steps 202 to 212 in FIG. 19 may refer generally to the development of a new endpoint applications and/or development of new endpoint types 16 for a given endpoint application. Turning now to FIG. 20, one embodiment for implementing steps 202, 208, and 210 to 212 is shown for creating a new endpoint type 16 for an application. At step 202a, access is provided to an administrator interface, e.g. through the CMS 20 or directly through the application server 12 (e.g. the browser front end 42). The application server 12 then enables the creation of a new endpoint type definition at step 202b. The user is then able to configure a new endpoint type 16, by performing step 208. In step 208, the user is able to configure how to detect the new endpoint type 16 at step 208a, is enabled to create the UI and content mappings at step 208b, and is enabled to configure other endpoint-specific variables at step 208c. Once the new endpoint type configuration is generated, the user is then enabled to create an endpoint specific runtime module 18 at step 210a. It may be noted that if the process shown in FIG. 20 is done in parallel for multiple endpoint types 16, step 210 may be repeated for each endpoint-specific runtime module 18, e.g. 210b, 210c, etc. The runtime module 18 can then be distributed to various endpoints 14 of that endpoint type 16 at step 212a, and the endpoint application can therefore be used on the associated platform.

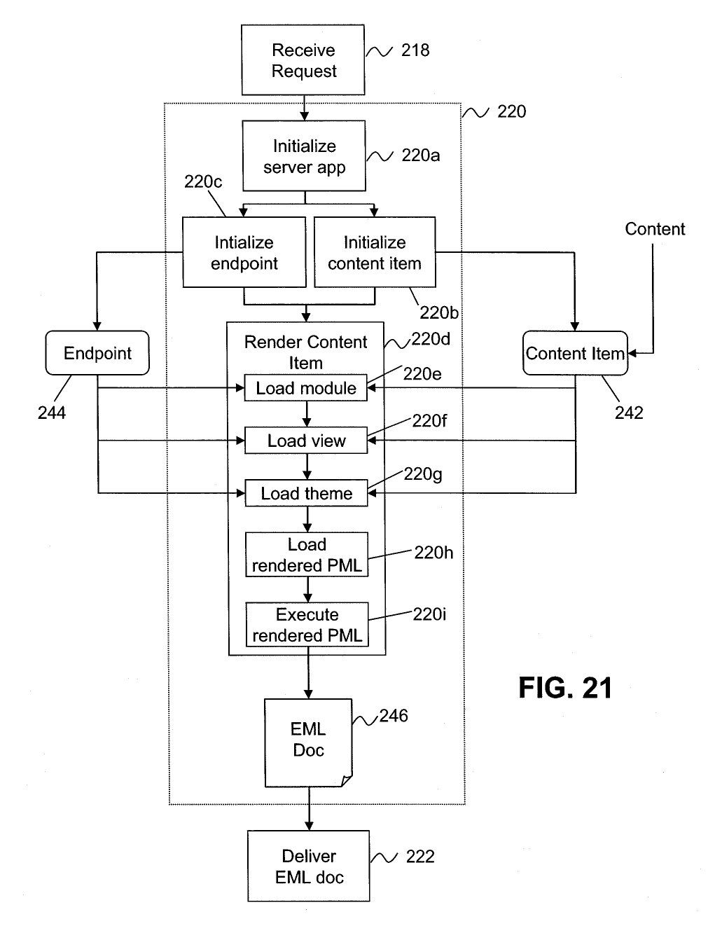

Referring back to FIG. 19, steps 218 to 222 are shown which exemplify the processing of a request 37 and the return of a response 35. One example for implementing steps 218 to 222 is shown in FIG. 21. As before, the application server 12 receives the request 37 at step 218. The EML content is then generated at step 220. FIG. 21 illustrates one way in which to generate EML content. At step 220a, a server application is initialized by the application server 12. The server application then initializes the content item class 242 at step 220b. The content item class 242 is a data structure that represents the content that is loaded from, e.g. the CMS 20 or the local cache 38. At step 220c, the server application initializes the endpoint class 244, which is an internal class that handles endpoint detection. The content item class 242 uses the endpoint class 244 to determine the requesting endpoint 14 and to then load the appropriate module, view, and theme. In one example, endpoint detection is done by evaluating an HTTP user agent, which is a header in the HTTP request that is read by the server application 12 to determine the endpoint type 16 of the requestor. However, this can be altered to define other ways of defining various endpoint types.

At step 220d, the content item class is rendered. This involves loading the module at step 220e, loading the view at step 220f, and loading the theme at step 220g. At step 220h, the thus rendered EML is loaded, and the rendered EML is executed at step 220i to generate an EML document 246. The EML document 246 may then be delivered (i.e. returned) to the requesting endpoint 14 at step 222.

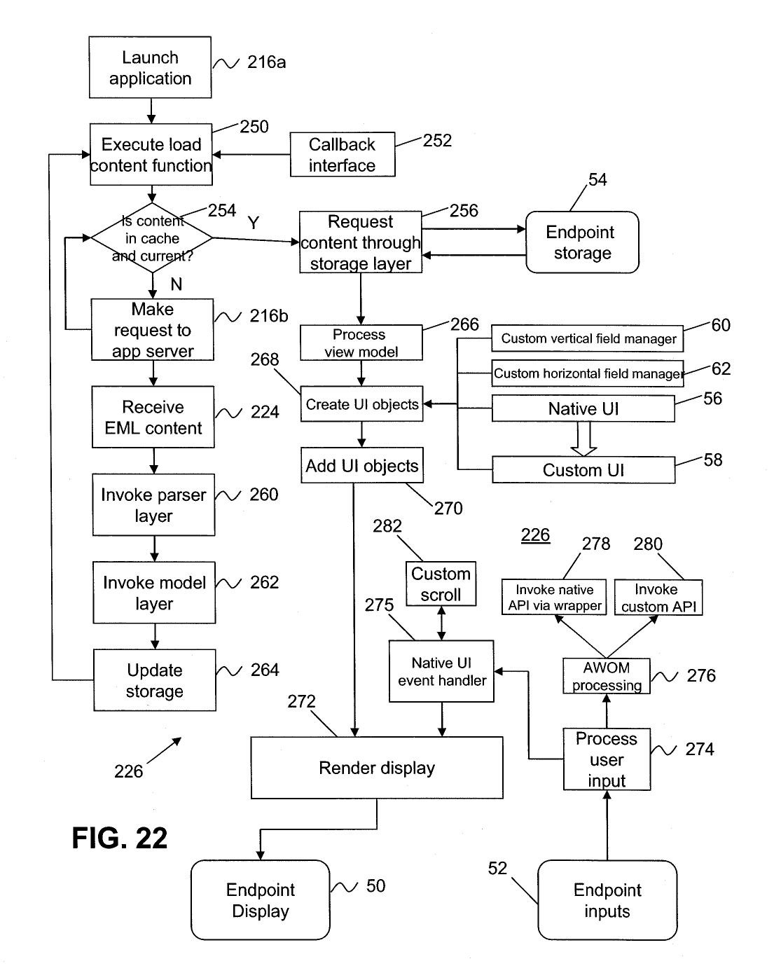

Again turning back to FIG. 19, the example shown therein provides step 216 for launching the endpoint application and making a request 37 and steps 224 and 226 for receiving a response 35, and parsing, rendering, and displaying the content according to the EML. FIG. 22 illustrates an exemplary set of operations for performing steps 216, 224, and 226. At step 216a, the endpoint application is launched, e.g. by detecting selection of an icon by a user. A load content function is then executed at step 250, which may rely on a call back interface at 252. Generally, the purpose of a call back interface is to invoke the load content function, since the call back interface 252 is typically only invoked once the network layer has downloaded the EML data required to display the content item. When an asynchronous network request is completed, the network layer invokes the provided call back interface. This avoids having to wait for all items to be obtained before others are displayed.

The controller 80 in the runtime module 18 should first check its local cache at step 254 to determine if some or all of the required content is already available locally and if it is current. If all content is available and current, a request 37 can be made through the storage layer 78 at step 256 and the data obtained from the endpoint storage 54. If at least some content is needed, e.g. if a portion of the content is dynamically updated and must be requested each time, step 216b may need to be executed, which comprises making a request 37 to the application server 12. Based on this request, the application server 12 returns a response 35 comprising an EML document 246, which is received at step 224. The parser layer 74 is then invoked at step 260, and the model layer 76 invoked at step 262 to obtain the content items and update the storage layer 78 at 264. The controller 80 then returns to step 250 to obtain the newly acquired content and continues with step 266. As such, it can be appreciated that step 256 can be executed either immediately if all content is available, or following a request/response procedure to obtain the missing content.

The controller 80 then processes the view model at step 266 to iterate over a hierarchical collection of UI model structures organized in a View Collection. As the controller 80 passes over each model, it accordingly creates native/custom UI elements and styling elements and adds them to a stack of UI objects that will be used to render the screen display. The controller 80 also creates UI objects with appropriate styling at step 268, using the custom vertical field manager 60, the custom horizontal field manager 62, and the native UI API 56, 58, and custom UI API 269. It may be noted that the custom UI 58 should be an extension of the pre-existing UI 56 in order to leverage the power of the native API whilst providing the flexibility of custom built UI experiences. Once the UI objects are created at step 268, the UI objects can be added at step 270 and rendered for display at step 272 and the associated data then provided to the endpoint display 50.

The render display step 272 also handles user interactions at any time during use of the application 100. From the endpoint inputs 52, user input is detected and processed at step 274. If the input relates to a native UI event, the input is processed by the native UI event handler at step 275, which, for example, may invoke a custom scroll at step 282. The user input may also be processed by the AWOM interpreter 96 at step 276, which either invokes custom API at step 280 or invokes native API 58 via a wrapper at step 278. Therefore, it can be seen that the AWOM processing allows the runtime module 18 to provide interactivity with the application 100 such that not only is UI/styling/content/themes etc. provided to each platform type, the native API can be leveraged and used if available to provide a look and feel that is consistent with what the endpoint 14 can offer. It may also be noted that the custom API can be thought of as an extension of the native API such that a developer, having access to definitions for the native API that is available to them for a particular platform (e.g. by storing such information at the application server 12), can create their own custom APIs that can be called using an AWOM message. This enables a developer to enhance the user experience without having to recreate APIs that already exist.

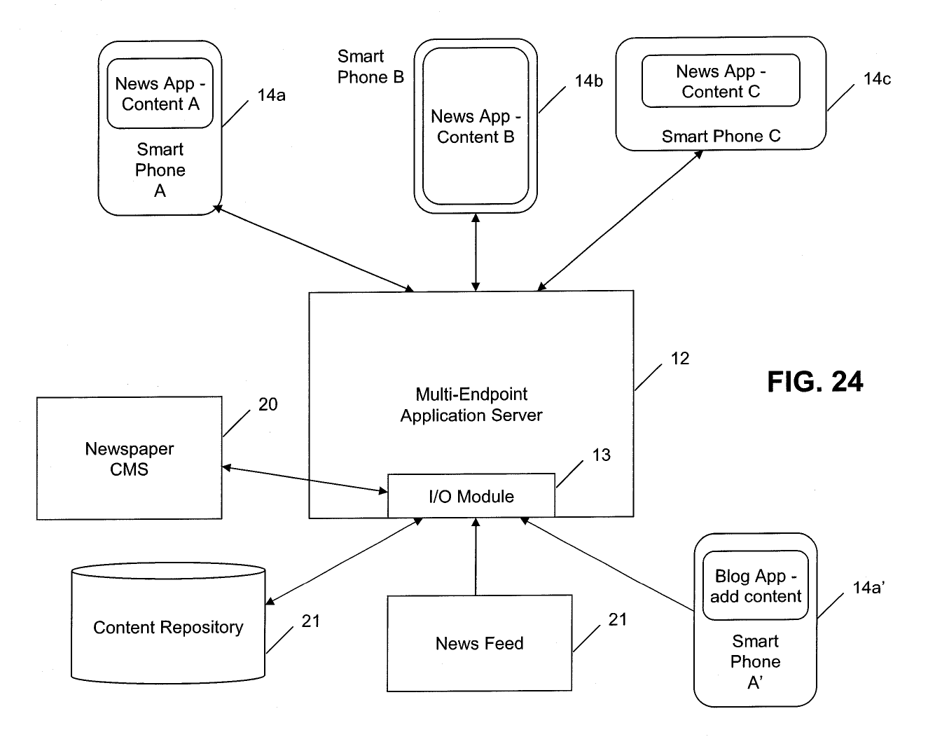

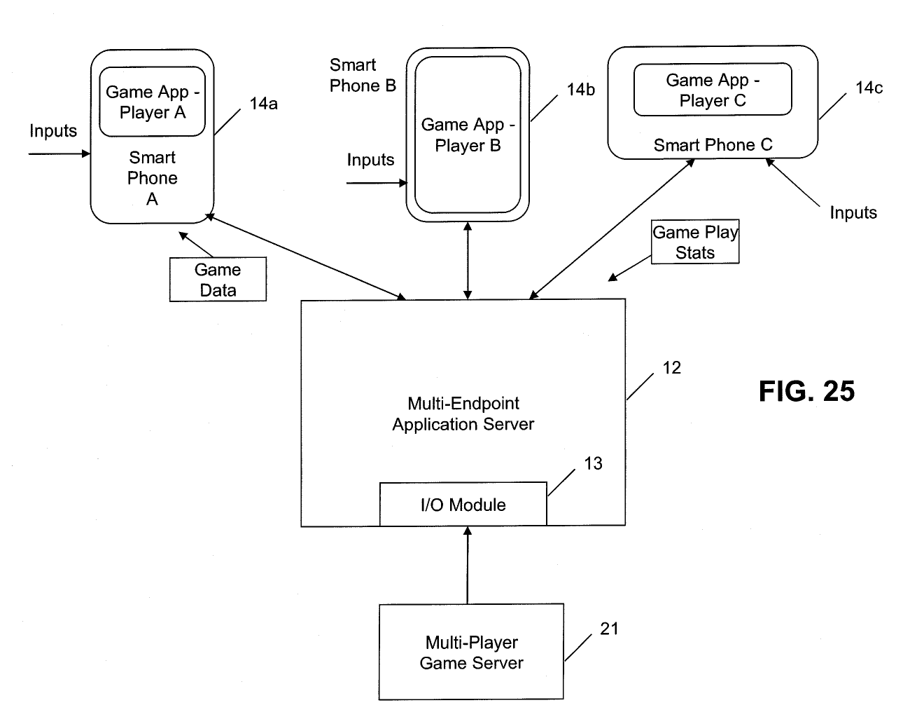

FIGS. 24 and 25 illustrate example use cases for the system 10. In FIG. 24, a media-based embodiment is shown wherein three different smart phone types are shown, namely Smart Phone A, Smart Phone B, and Smart Phone C, which each operate on a unique platform. The system 10 can be used to deploy a runtime module 18 (not shown for simplicity) to each smart phone 14a, 14b, 14c for displaying news content and such news content is displayed to the user using custom look-and-feel according to the smart phone type. The news application can be dynamically up-to-date by gathering, in this example, content and data from a newspaper CMS 20 (e.g. the newspaper whose brand is associated with the application), a content repository 21 (e.g. 3^{rd} party news store), and other news feed 21 (e.g. stock ticker, weather, etc.) can be handled through the I/O module 13 to combine the raw data and content with styling, views, and other UI aspects that is appropriate for each smart phone type 16. In this way, as the users select different news articles, the content can be fetched and rendered in an appropriate way for the requesting endpoint type 16. Also shown in FIG. 24 is another smart phone A which is used by a blogger to dynamically add news content through a blog application. This illustrates that the runtime module 18 can also be used to add content and data and push this out to multiple platforms. In a related example, company announcements or other employee information could be generated by one person using one platform but still be supported by devices carried by all employees, even if on different platforms.

Another example use case is shown in FIG. 25, wherein a multi-player game server acts as the source 21 for a gaming experience. In this example, the application server 12 enables game play to occur across multiple platforms by translating game data and game play statistics for the game server 21. In this way, the application server 12 can handle requests for game UI so that the mobile game application can render game play. As the user interacts with the game, game stats, moves, etc. can be sent to the application server 12 in subsequent requests and game play managed from the game server 21. By providing a central hub for the exchange of game data and game play stats, players that use different platforms can still play against each other.

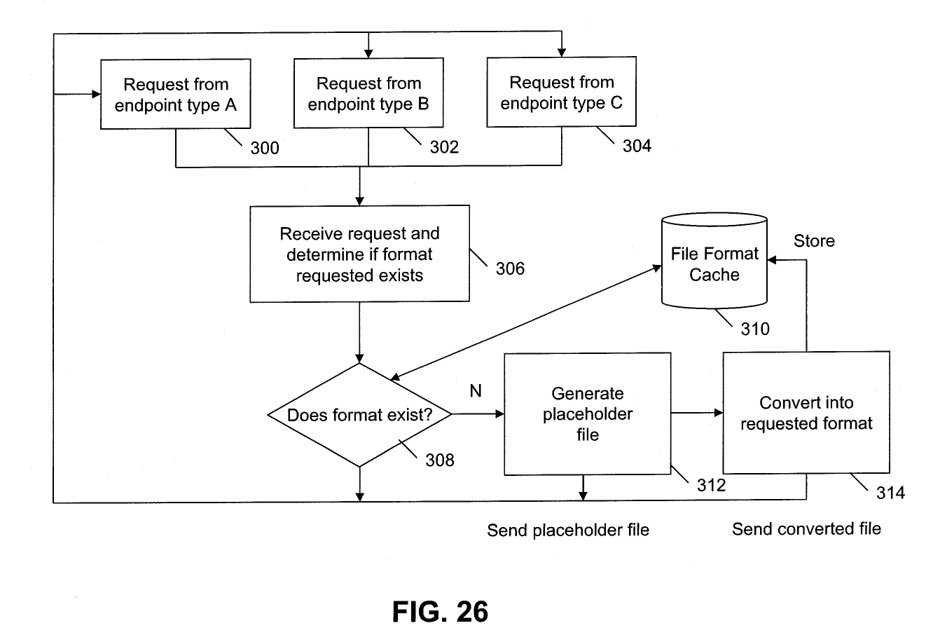

It has also been recognized that by enabling the application server 12 to communicate with multiple endpoint types 16, in some instances, one particular endpoint type 16 will request one version or format of a requested multimedia file while another endpoint type 16 will request another. To accommodate such situations, on-the-fly multimedia conversion can be incorporated into the above-described system 10. As shown in FIG. 26, a first request 300 may be sent by endpoint type A, a second request 302 may be sent by endpoint type B, and a third request 304 sent by endpoint type C, each of which is requesting the same multimedia file (e.g. audio file, video, image, etc.) but in different formats or versions, sizes, etc. To address this situation, the application server 12 receives a particular request at 306 and determines at 308 if the format requested exists in their file format cache 310. For example, if another endpoint 14 of the same type 16 has previously made the same request and the multimedia file has already been converted, then the application server 12 can simply provide a copy of the previously converted file. If on the other hand the requested format does not exist, in this example, a placeholder file (e.g. a message or video indicating that the conversion is in process) may be generated at 312 and sent back to the endpoint 14 making the request. It can be appreciated that instead of generating the placeholder at 312, the application server 12 can send an instruction to the endpoint 14 to have the runtime module 16 do so if configured as such.

The application server 12 then converts the multimedia file to the requested format at 314 and the converted file is sent back to the requesting endpoint 14. Since the application server 12 in the above examples is responsible for providing the content, they should already have the multimedia file and can determine if the conversion process is needed at any suitable time, e.g. by initiating the request 300, 302, 304 prior to sending the file. In this way, the files can be converted on the fly and adapt to different endpoint types 16. By storing previously converted versions and formats, subsequent requests can be handled more expeditiously.

Although the above has been described with reference to certain specific embodiments, various modifications thereof will be apparent to those skilled in the art.

1. A method for providing applications on multiple endpoint types, the method comprising:
providing a runtime module capable of creating a user interface for an endpoint application on a particular endpoint type, from instructions provided in a communications protocol; and
using the communications protocol to receive requests from the runtime module and to provide replies to the runtime module.

2. The method according to claim 1, wherein upon receiving a request, the method comprises:
determining the particular endpoint type;
generating data to be used by the runtime module according to the request, the data being compatible with the particular endpoint type; and
providing the content to the runtime module.

3. The method according to claim 1, wherein the data comprises any one or more of media content, logic, and user interface data.

4. The method according to claim 2, wherein the data is generated using a mark-up language.

5. The method according to claim 1, further comprising:
enabling creation of a new endpoint type definition;
enabling a new endpoint type confirmation;
enabling creation of a new runtime module for the new endpoint type; and
providing access to the new runtime module for enabling devices of the new endpoint type to communicate in accordance with the communications protocol.

6. The method according to claim 5, wherein the new endpoint type definition is created by determining how to detect the new endpoint type, enabling creation of user interface and content mappings, and enabling configuration of one or more endpoint specific variables.

7. The method according to claim 1, wherein upon receiving a request from the particular endpoint type, the method comprises:
determining if a format for requested data is immediately available;
if the format is not immediately available, converting the data into the requested format; and
sending converted data to the particular endpoint type.

8. The method according to claim 7, further comprising storing the converted data for providing to other devices of the particular endpoint type in later requests.

9. The method according to claim 7, further comprising generating a placeholder file and returning the placeholder file to the particular endpoint type, the placeholder file providing an indication that data conversion is taking place.

10. The method according to claim 7, wherein the requested data comprises any one or more of an image, a video, an audio file, and text.

11. The method according to claim 1, further comprising:
enabling an update or revision to an endpoint definition corresponding to the particular endpoint type; and
if the update or revision requires the runtime module to be updated, providing a runtime module update using the communications protocol.

12. A computer readable medium comprising computer executable instructions for performing the method according to claim 1.

13. A server device comprising a processor and memory, the memory storing computer executable instructions that when executed by the processor, cause the processor to perform the method according to claim 1.

14. A method for providing applications on multiple endpoint types, the method comprising:
a particular endpoint type obtaining a runtime module capable of creating a user interface for an endpoint application using instructions provided in a communications protocol;
the particular endpoint type using the runtime module for sending a request to an application server pertaining to use of the endpoint application;
the particular endpoint type receiving a reply in accordance with the communications protocol with the instructions, the reply comprising data to be used by the endpoint application; and
the endpoint application parsing the replay and generating the user interface (UI).

15. The method according to claim 14, wherein prior to sending the request, the method comprises:
launching the endpoint application;
determining content to be loaded for the endpoint application;
determining if any of the content has been cached;
if any of the content to be loaded has been cached, obtaining the cached data from a local memory; and
if any of the content to be loaded has not been cached, including content that has not been cached in the request.

16. The method according to claim 14, further comprising initiating a callback interface to enable processing of portions of data in the reply before all of the data being received has been received.

17. The method according to claim 14, wherein the parsing comprises:
obtaining content to be used in by the endpoint application;
processing a collection of UI model structures;
creating one or more UI objects;
adding the UI objects to the user interface; and
rendering the user interface on a display.

18. The method according to claim 14, further comprising enabling detection of user interactions, wherein if the a user interaction corresponds to a need for additional content, a further request is initiated by the endpoint application.

19. The method according to claim 14, wherein the request indicates a format for data being requested, and wherein if the format is not immediately available, the method further comprises receiving converted data from the application server.

20. The method according to claim 19, further comprising receiving a placeholder file from the application server, the placeholder file providing an indication that data conversion is taking place.

21. The method according to claim 19, wherein the requested data comprises any one or more of an image, a video, an audio file, and text.

22. The method according to claim 14, wherein the data to be used by the endpoint application comprises any one or more of media content, logic, and user interface data.

23. The method according to claim 14, wherein the data to be used by the endpoint application has been generated using a mark-up language.

24. A computer readable medium comprising computer executable instructions for performing the method according to claim 14.

25. A device comprising a processor, memory, and a communication subsystem, the device being of a particular endpoint type and comprising computer executable instructions stored in the memory that when executed cause the processor to perform the method according to claim 14.

26. A method for enabling interactivity with an endpoint application, said method comprising:
obtaining a message sent in response to a detected event;
interpreting said message to determine one or more instructions for responding to said detected event; and
providing said instructions to native or custom application programming interfaces (APIs) to perform a response to said event.

27. The method according to claim 26, wherein the detected event comprises any one or more of an interaction with a user interface, and receipt of new content.

28. The method according to claim 26, wherein the message is an object oriented message which can be interpreted into instructions for dynamically generating code to execute on the endpoint application to respond to interactivity with the endpoint application.

29. The method according to claim 26, wherein the messages are common to multiple endpoint types to enable a same message to be interpreted by the multiple endpoint types without custom programming.

30. A computer readable medium comprising computer executable instructions for performing the method according to claim 26.

31. A device comprising a processor, memory, and a communication subsystem, the device being of a particular endpoint type and comprising computer executable instructions stored in the memory that when executed cause the processor to perform the method according to claim 26.
